(19) United States
(12) Patent Application Publication
(10) Pub. No.: US 2022/0188570 A1
(43) Pub. Date: Jun. 16, 2022

(54) LEARNING APPARATUS, LEARNING METHOD, COMPUTER PROGRAM AND RECORDING MEDIUM

(71) Applicant: NEC Corporation, Minato-ku, Tokyo (JP)

(72) Inventor: Yohei Iizawa, Tokyo (JP)

(73) Assignee: NEC Corporation, Minato-ku, Tokyo (JP)

(21) Appl. No.: 17/436,728

(22) PCT Filed: Feb. 17, 2020
(86) PCT No.: PCT/JP2020/006039

§ 371 Date: Sep. 7, 2021

(30) Foreign Application Priority Data
Mar. 19, 2019 (JP) 2019-051063

(51) Int. Cl. G06K 9/62

(52) U.S. Cl. CPC G06K 9/6257; G06K 9/6262

(57) ABSTRACT

A learning apparatus includes: a generating unit that generates a learning model for predicting and outputting time-series data corresponding to inputted time-series data, by performing machine learning using normal data that are time-series data indicating normal state; a first obtaining unit that compares predicted normal data in a second period predicted by inputting normal data in a first period into the learning model to obtain a first deviation degree; a second obtaining unit that compares predicted abnormal data in a fourth period predicted by inputting, into the learning model, abnormal data that is time-series data indicating abnormal state in a third period; and a detecting unit that detects an insufficient time-series pattern from among time-series patterns indicating the normal state relating to the normal data, on the basis of the first deviation degree and the second deviation degree.

### TECHNICAL FIELD

The present invention relates to a learning apparatus, a learning method, a computer program and a recording medium.

### BACKGROUND ART

For example, due to technological progress in machine learning, which is represented by deep learning, there is an increasing need for automatic detection of abnormalities in a device, for example, based on time-series numerical data (hereinafter referred to as “time-series data” as occasion demands) outputted from sensors attached to the device.

Meanwhile, in a machine learning technique, a large amount of training data are required to achieve high accuracy. In order to build a learning model for the automatic detection of abnormalities in the device described above by the machine learning, it is necessary to sufficiently collect both time-series data indicating a normal state (hereinafter referred to as “normal data” as occasion demands) and time-series data indicating an abnormal state (hereinafter referred to as “abnormal data” as occasion demands) as the training data. In practice, however, the abnormal data caused by a failure of the device or the like are by far less than the normal data. Therefore, there is a technical problem that it is difficult to collect a sufficient amount of abnormal data to build the above-described learning model. With respect to this problem, there is proposed such a technique that a normal pattern, which is a time-series pattern indicated by the normal data, is learned by the machine learning that uses only the normal data and then an abnormality is detected from a degree of deviation of time-series data with respect to the learned normal pattern (refer to Patent Literature 1). Other related techniques include Patent Literatures 2 to 7.

### CITATION LIST

### Patent Literature

Patent Literature 1: JP 2018-124937A
Patent Literature 2: International Publication No. 2017/94267
Patent Literature 3: International Publication No. 2014/132611
Patent Literature 4: JP 2018-148350A
Patent Literature 5: JP 2017-91278A
Patent Literature 6: JP 2017-10111A
Patent Literature 7: JP 2004-94437A

### SUMMARY OF INVENTION

### Technical Problem

A learning model built by the machine learning that uses only the normal data often has a relatively low accuracy. This is because it is actually difficult to collect the normal data that indicate various normal patterns in a comprehensive manner and in large quantities. It is time consuming, costly, and not advisable to manually analyze the already-collected normal data to specify an insufficient normal pattern, and to collect the normal data that indicate the specified normal pattern.

In view of the above-described problems, it is therefore an example object of the present invention to provide a learning apparatus, a learning method, a computer program, and a recording medium that are configured to detect the normal pattern that is insufficient for machine learning.

### Solution to Problem

A learning apparatus according to an example aspect of the present invention is a learning apparatus that performs machine learning by using time-series numerical data as input data, the learning apparatus including: a generating unit that generates a learning model for predicting and outputting time-series numerical data corresponding to inputted time-series numerical data, by performing the machine learning by using normal data that are time-series numerical data indicating a normal state as the input data; a first obtaining unit that compares predicted normal data in a second period corresponding to a first period, which are normal data predicted by the learning model by inputting, into the learning model, normal data in the first period out of the normal data, with normal data in the second period out of the normal data to obtain a first deviation degree indicating an extent of deviation between the normal data in the second period and the predicted normal data; a second obtaining unit that compares predicted abnormal data in a fourth period corresponding to a third period, which are abnormal data predicted by the learning model by inputting, into the learning model, abnormal data in the third period out of abnormal data that are time-series numerical data indicating an abnormal state, with abnormal data in the fourth period out of the abnormal data to obtain a second deviation degree indicating an extent of deviation between the abnormal data in the fourth period and the predicted abnormal data; and a detecting unit that detects an insufficient time-series pattern from among time-series patterns indicating the normal state relating to the normal data, on the basis of the first deviation degree and the second deviation degree.

A learning method according to an example aspect of the present invention is a learning method in a learning apparatus that performs machine learning by using time-series numerical data as input data, the learning method including: a generating step that generates a learning model for predicting and outputting time-series numerical data corresponding to inputted time-series numerical data, by performing the machine learning by using normal data that are time-series numerical data indicating a normal state as the input data; a first obtaining step that compares predicted normal data in a second period corresponding to a first period, which are normal data predicted by the learning model by inputting, into the learning model, normal data in the first period out of the normal data, with normal data in the second period out of the normal data to obtain a first deviation degree indicating an extent of deviation between the normal data in the second period and the predicted normal data; a second obtaining step that compares predicted abnormal data in a fourth period corresponding to a third period, which are abnormal data predicted by the learning model by inputting, into the learning model, abnormal data in the third period out of abnormal data that are time-series numerical data indicating an abnormal state, with abnormal data in the fourth period out of the abnormal data to obtain a second deviation degree indicating an extent of deviation between the abnormal data in the fourth period and the predicted abnormal data; and a detecting step that detects an insufficient time-series pattern from among time-series patterns indicating the normal state relating to the normal data, on the basis of the first deviation degree and the second deviation degree.

A computer program according to an example aspect of the present invention allows a computer to perform the learning method according to the example aspect described above.

A recording medium according to an example aspect of the present invention is a recording medium on which the computer program according to the example aspect described above is recorded.

### Advantageous Effects of Invention

According to the learning apparatus, the learning method, the computer program, and the recording medium in the respective example aspects described above, it is possible to detect the normal pattern that is insufficient for machine learning.

### BRIEF DESCRIPTION OF DRAWINGS

FIG. 1 a block diagram illustrating a hardware configuration of a learning apparatus according to an example embodiment.

FIG. 2 is a block diagram illustrating a functional block implemented in the CPU according to the example embodiment.

FIG. 3 is a conceptual diagram illustrating a concept of learning and validation.

FIG. 4 is a flowchart illustrating a learning operation according to the example embodiment.

FIG. 5 is a flowchart illustrating a validation operation according to the example embodiment.

FIG. 6 is a conceptual diagram illustrating a concept of a method of detecting insufficient data.

FIG. 7 is a block diagram illustrating a functional block implemented in a CPU according to a modified example.

FIG. 8 is a flowchart illustrating a validation operation according to the modified example.

### DESCRIPTION OF EXAMPLE EMBODIMENTS

A learning apparatus, a learning method, a computer program, and a recording medium according to an example embodiment will be described with reference to the drawings. The following describes the learning apparatus, the learning method, the computer program, and the recording medium according to the example embodiment, by using a learning apparatus 1 that detects normal data with the normal pattern that is insufficient for the normal data that are training data (hereinafter referred to as “insufficient data” as occasion demands).

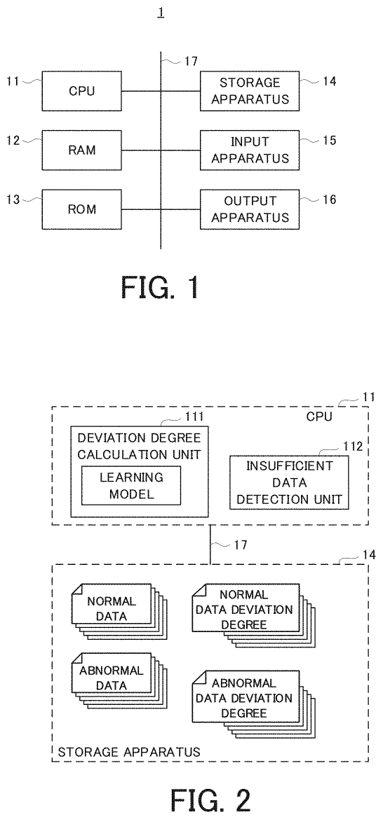

(Configuration) First, a hardware configuration of the learning apparatus 1 according to the example embodiment will be described with reference to FIG. 1. FIG. 1 is a block diagram illustrating the hardware configuration of the learning apparatus 1 according to the example embodiment.

In FIG. 1, the learning apparatus 1 includes a CPU (Central Processing Unit) 11, a RAM (Random Access Memory) 12, a ROM (Read Only Memory) 13, a storage apparatus 14, an input apparatus 15, and an output apparatus 16. The CPU 11, the RAM 12, the ROM 13, the storage apparatus 14, the input apparatus 15 and the output apparatus 16 are interconnected through a data bus 17.

The CPU 11 reads a computer program. For example, the CPU 11 may read a computer program stored by at least one of the RAM 12, the ROM 13 and the storage apparatus 14. For example, the CPU 11 may read a computer program stored in a computer-readable recording medium, by using a not-illustrated recording medium reading apparatus. The CPU 11 may obtain (i.e., read) a computer program from a not-illustrated apparatus disposed outside the learning apparatus 1, through a network interface. The CPU 11 controls the RAM 12, the storage apparatus 14, the input apparatus 15, and the output apparatus 16 by executing the read computer program. Especially in this example embodiment, when the CPU 11 executes the read computer program, a logical functional block for detecting insufficient data is implemented in the CPU 11. In other words, the CPU 11 is configured to function as a controller for detecting insufficient data. A configuration of the functional block implemented in the CPU 11 will be described in detail later with reference to FIG. 2.

The RAM 12 temporarily stores the computer program to be executed by the CPU 11. The RAM 12 temporarily stores the data that are temporarily used by the CPU 11 when the CPU 11 executes the computer program. The RAM 12 may be, for example, a D-RAM (Dynamic RAM).

The ROM 13 stores a computer program to be executed by the CPU 11. The ROM 13 may otherwise store fixed data. The ROM 13 may be, for example, a P-ROM (Programmable ROM).

The storage apparatus 14 stores the data that are stored for a long term by the learning apparatus 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the learning apparatus 1. The incoming apparatus 15 may include, for example, at least one of a keyboard, a mouse, and a touch panel.

The output apparatus 16 is an apparatus that outputs information about the learning apparatus 1, to the outside. For example, the output apparatus 16 may be a display apparatus that is configured to display the information about the learning apparatus 1.

Next, the configuration of the functional block implemented in the CPU 11 will be described with reference to FIG. 2. FIG. 2 is a block diagram illustrating the functional block implemented in the CPU11.

As illustrated in FIG. 2, a deviation degree calculation unit 111 and an insufficient data detection unit 112 are implemented in the CPU11 as the logical function block for detecting the insufficient data. The deviation degree calculation unit 111 builds (or generates) a learning model by machine learning, by using normal data as the training data. Then, the deviation degree calculation unit 111 stores, in the storage apparatus 14, a result of validating the learning model by using normal data for validation, which are different from the normal data used for the machine learning, as a normal data deviation degree. The deviation calculation unit 111 further stores, in the storage apparatus 14, a result of validating the learning model by using abnormal data as an abnormal data deviation degree. The insufficient data detection unit 112 detects the insufficient data on the basis of the normal data deviation degree and the abnormal data deviation degree.

(Operation)

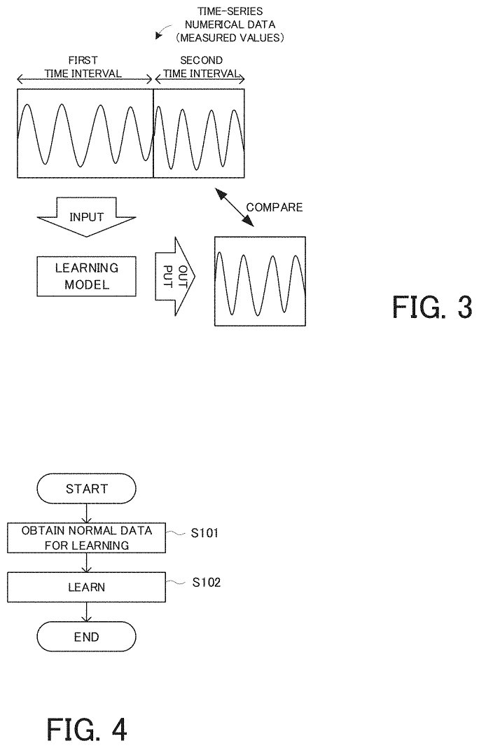

Next, the machine learning in the deviation degree calculation unit 111 will be described with reference to FIG. 3 and FIG. 4. Here, it is assumed that measured values of time-series data illustrated in FIG. 3 correspond to an example of the normal data described above. The deviation degree calculation unit 111, for example, reads time-series data in a first time interval from among the measured values of the time-series data illustrated in FIG. 3 and builds a learning model for predicting (or reproducing) and outputting time-series data in a second time interval following the first time interval. At this time, the accuracy of the learning model is improved by comparing the predicted time-series data in the second time interval with time-series data in the second time interval (corresponding to the training data) out of the measured values of the time-series data.

In a flowchart in FIG. 4, the deviation degree calculation unit 111 first obtains normal data for learning from among the normal data stored in the storage apparatus 14 (step S101). Then, the deviation degree calculation unit 111 generates a plurality of sets of the time-series data in the first time interval that are to be inputted into the learning model and the time-series data in the second time interval that is the training data, from the normal data for learning obtained in the step S101 (refer to FIG. 3). Then, the deviation degree calculation unit 111 performs the machine learning that uses the generated sets of the time-series data, and builds the learning model (step S102).

Specific methods of building a learning model may include, for example, a method in which an input can be reproduced, such as an auto encoder in deep learning, a method in which time-series data can be outputted from time-series data, such as a recurrent neural network, and the like. When the normal data for learning are time-series data as a sensor output and there are a plurality of time-series data outputted from each of a plurality of sensors, the deviation degree calculation unit 111 may build one learning model by using the plurality of time-series data, or may build a learning model for each sensor. The “deviation degree calculation unit 111” corresponds to an example of the “generating unit” in Supplementary Note that will be described later.

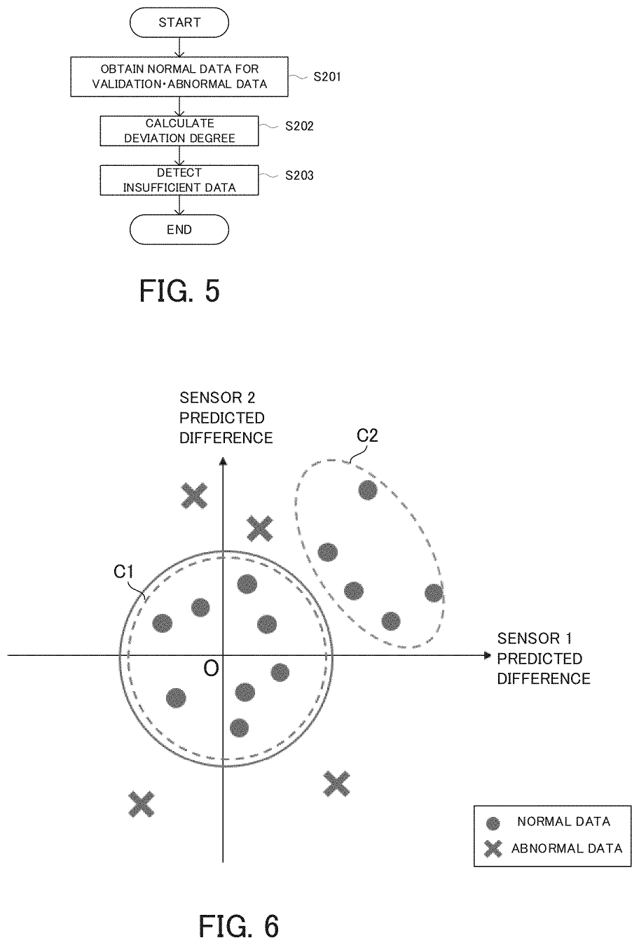

Next, the validation of the learning model built as described above will be described with reference to FIG. 3 and FIG. 5. The validation of the learning model using the normal data will be described on the assumption that the measured values of the time-series data illustrated in FIG. 3 correspond to an example of the normal data for validation. The deviation degree calculation unit 111 inputs the time-series data in the first time interval out of the measured values of the time-series data illustrated in FIG. 3 into the learning model, and obtains the predicted time-series data that are predicted by the learning model and that are the time-series data in the second time interval following the first time interval. Then, the deviation degree calculation unit 111 calculates a difference between the predicted time-series data and the time-series data in the second time interval out of the measured values of the time-series data, as a predicted difference.

The deviation degree calculation unit 111 calculates a deviation degree, which is an index indicating a degree of deviation (in other words, an extent of deviation) of the predicted time-series data from the measured values of the time-series data in the second time interval, on the basis of the predicted difference. The deviation degree calculated when the learning model is validated by using the normal data for validation is stored in the storage apparatus 14 as the normal data deviation degree.

Even when the learning model is validated by using abnormal data, the deviation degree is calculated by the same process as described above. The deviation degree calculated when the learning model is validated by using the abnormal data is stored in the storage apparatus 14 as the abnormal data deviation degree.

The “first time interval” and the “second time interval” relating to the normal data for validation respectively correspond to an example of the “first period” and the “second period” in Supplementary Note that will be described later. The “first time interval” and the “second time interval” relating to the abnormal data respectively correspond to an example of the “third period” and the “fourth period” in Supplementary Note that will be described later.

The deviation degree may be expressed, for example, as an average of absolute values of the predicted difference, or may be expressed as a liner combination of a vector when the predicted difference is expressed as the vector. Alternatively, the deviation degree may be represented by the Euclidean distance or Mahalanobis distance when the predicted difference is expressed as a vector. In any case, the deviation degree may be anything that expresses the magnitude of deviation from the measured values by a numerical value.

The insufficient data detection unit 112 specifies the normal data deviation degree indicating a deviation degree that is larger than a reference based on the deviation degree indicated by the abnormal data deviation degree. The insufficient data detection unit 112 detects insufficient data from the normal pattern indicated by the normal data that is the basis of the specified normal data deviation degree (that is, the normal data that is used when the predicted difference that is the basis of the specified normal data deviation degree is calculated).

In a flowchart in FIG. 5, the deviation degree calculation unit 111 first obtains the normal data for validation from among the normal data stored in the storage apparatus 14, and obtains the abnormal data (step S201). Then, the deviation calculation unit 111 generates a plurality of sets of the time-series data in the first time interval that are to be inputted into the learning model and the time-series data in the second time interval, from each of the normal data for validation and the abnormal data obtained in the step S201 (refer to FIG. 3).

Then, the deviation degree calculation unit 111 inputs the time-series data in the first time interval out of the normal data for validation into the learning model, and obtains the predicted time-series data that are predicted by the learning model. The deviation degree calculation unit 111 calculates the difference between the predicted time-series data and the time-series data in the second time interval out of the normal data for validation, as the predicted difference. The deviation degree calculation unit 111 calculates the normal data deviation degree on the basis of the calculated prediction difference. Similarly, the deviation degree calculation unit 111 inputs the time-series data in the first time interval out of the abnormal data into the learning model, and obtains the predicted time-series data that are predicted by the learning model. The deviation degree calculation unit 111 calculates the difference between the predicted time-series data and the time-series data in the second time interval out of the abnormal data, as the predicted difference. The deviation degree calculation unit 111 calculates the abnormal data deviation degree on the basis of the calculated predicted difference (step S202).

The insufficient data detection unit 112 specifies the normal data deviation degree indicating the deviation degree that is larger than the reference based on the deviation degree indicated by the abnormal data deviation degree. The insufficient data detection unit 112 detects the insufficient data on the basis of the specified normal data deviation degree (step S203). The “deviation degree calculation unit 111” corresponds to an example of the “first obtaining unit” and the “second obtaining unit” in Supplementary Note that will be described later, and the “insufficient data detection unit 112” corresponds to an example of the “detecting unit” in Supplementary Note that will be described later.

Here, a concept of the detection of the insufficient data will be described with reference to FIG. 6. FIG. 6 illustrates the deviation degrees calculated by using the normal data and the abnormal data based on the time-series data outputted from each of a sensor 1 and a sensor 2. It is assumed that the targets of the sensor 1 and the sensor 2 are interrelated and that one event that occurs at a certain time point influences the time-series data outputted from each of the sensor 1 and the sensor 2. Here, the deviation degree is represented by the Mahalanobis distance when the predicted difference is expressed as a vector. The data (i.e., the normal data and the abnormal data) with a smaller predicted difference are plotted closer to the origin O. When the minimum value of the abnormal data deviation degrees (refer to X marks in FIG. 6) is used as a reference, it can be said that the normal data deviation degrees surrounded by a dashed line circle C1 are normal data with a normal pattern on which machine learning is sufficiently performed when a learning model is built, because the deviation degrees are smaller than the reference. On the other hand, it can be said that the normal data deviation degrees surrounded by a dashed line circle C2 are normal data with a normal pattern on which the machine learning is not sufficiently performed when the learning model is built, because the deviation degrees are larger than the reference described above.

When the machine learning is sufficient, the predicted time-series data predicted by the learning model are close to the measured values of the time-series data, so that the predicted difference becomes relatively small, and as a result, the deviation degree also becomes relatively small. On the other hand, when the machine learning is insufficient, the predicted time-series data predicted by the learning model relatively significantly deviates from the measured values of the time-series data, so that the predicted difference becomes relatively large, and as a result, the deviation degree becomes relatively large. In the learning apparatus 1, the learning model is built by the machine learning that uses the normal data for learning (i.e., by the machine learning that uses only the normal data). Thus, of course, the abnormal data deviation degree calculated when the learning model is validated by using the abnormal data that is not used for the machine learning becomes relatively large. Therefore, it can be said that machine learning is not sufficient for the normal data with a deviation degree that is greater than the abnormal data deviation degree.

The minimum value of the abnormal data deviation degree may not be the reference; for example, the average value, the median value or the maximum value of the abnormal data deviation degree may be used as the reference. Alternatively, an intermediate value between the minimum value of the abnormal data deviation degree and the maximum value of the normal data deviation degree of a plurality of normal data deviation degrees that are smaller than the minimum value may be used as a reference.

### Technical Effects

According to the learning apparatus 1, it is possible to automatically detect normal data with the normal pattern that is insufficient for machine learning (i.e., insufficient data). Therefore, when the normal data for learning corresponding to the detected insufficient data are added, it is possible to improve the accuracy of the learning model, relatively easily. As a result, even when the abnormal data used for the machine learning cannot be sufficiently collected, it is possible to build the learning model with relatively good accuracy by using only the normal data. In addition, it is possible to drastically reduce the number of steps for building the learning model because it is not necessary to manually analyze the already-collected normal data to specify the insufficient data.

Here, the learning model used to detect the insufficient data may be the same as or may be different from the learning model used to automatically detect the abnormality of a target device on the basis of the time-series data. In any case, when the normal data for learning corresponding to the detected insufficient data is added and relearning is performed, then, it is possible to improve the accuracy of the learning model used to automatically detect the abnormality of the target device. As a result, it is possible to accurately detect the abnormality of the target device by using the relearned learning model.

### Modified Examples

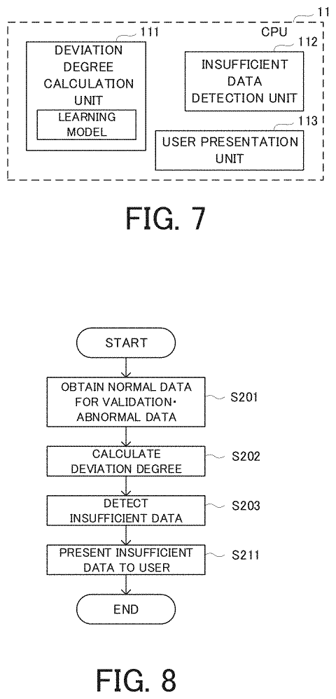

(1) As illustrated in FIG. 7, in addition to the deviation degree calculation unit 111 and the shortage data detection unit 112, a user presentation unit 113 may be implemented in the CPU11. As illustrated in FIG. 8, after the step S203, the user presentation unit 113 may control the output apparatus 16 (refer to FIG. 1) such that the insufficient data detected in the step S203 are presented to the user of the learning apparatus 1. At this time, for example, an image as illustrated in FIG. 5 may be presented to the user.

When the number of sensors whose targets are interrelated is 4 or more and when the deviation degree is represented by the Euclidean distance or Mahalanobis distance, the number of dimensions is 4 or more, and thus, it is desirable to present, for example, a plurality of two-dimensional or three-dimensional graphs. When the targets of the plurality of sensors are not interrelated (e.g., when an event that occurs in one sensor does not influence time-series data outputted from another sensor that is different from the one sensor), then, a plurality of one-dimensional graphs may be presented. The “user presentation unit 113” corresponds to an example of the “presenting unit” in Supplementary Note that will be described later.

(2) In the example embodiment described above, the learning model for predicting the time-series data in the second time interval following the first time interval from the time-series data in the first time interval out of the time-series data is built, but it is not limited to this example embodiment. For example, a learning model for predicting time-series data of the time interval that is the same as a time interval relating to inputted time-series data may be built.

<Supplementary Note>

With respect to the example embodiments described above, the following Supplementary Notes will be further disclosed.

(Supplementary Note 1)

The learning apparatus described in Supplementary Note 1 is a learning apparatus that performs machine learning by using time-series numerical data as input data, the learning apparatus including: a generating unit that generates a learning model for predicting and outputting time-series numerical data corresponding to inputted time-series numerical data, by performing the machine learning by using normal data that are time-series numerical data indicating a normal state as the input data; a first obtaining unit that compares predicted normal data in a second period corresponding to a first period, which are normal data predicted by the learning model by inputting, into the learning model, normal data in the first period out of the normal data, with normal data in the second period out of the normal data to obtain a first deviation degree indicating an extent of deviation between the normal data in the second period and the predicted normal data; a second obtaining unit that compares predicted abnormal data in a fourth period corresponding to a third period, which are abnormal data predicted by the learning model by inputting, into the learning model, abnormal data in the third period out of abnormal data that are time-series numerical data indicating an abnormal state, with abnormal data in the fourth period out of the abnormal data to obtain a second deviation degree indicating an extent of deviation between the abnormal data in the fourth period and the predicted abnormal data; and a detecting unit that detects an insufficient time-series pattern from among time-series patterns indicating the normal state relating to the normal data, on the basis of the first deviation degree and the second deviation degree.

(Supplementary Note 2)

The learning apparatus described in Supplementary Note 2 is the learning apparatus described in Supplementary Note 1, further including a presenting unit that presents the detected insufficient time-series pattern.

(Supplementary Note 3)

The learning method described in Supplementary Note 3 is a learning method in a learning apparatus that performs machine learning by using time-series numerical data as input data, the learning method including: a generating step that generates a learning model for predicting and outputting time-series numerical data corresponding to inputted time-series numerical data, by performing the machine learning by using normal data that are time-series numerical data indicating a normal state as the input data; a first obtaining step that compares predicted normal data in a second period corresponding to a first period, which are normal data predicted by the learning model by inputting, into the learning model, normal data in the first period out of the normal data, with normal data in the second period out of the normal data to obtain a first deviation degree indicating an extent of deviation between the normal data in the second period and the predicted normal data; a second obtaining step that compares predicted abnormal data in a fourth period corresponding to a third period, which are abnormal data predicted by the learning model by inputting, into the learning model, abnormal data in the third period out of abnormal data that are time-series numerical data indicating an abnormal state, with abnormal data in the fourth period out of the abnormal data to obtain a second deviation degree indicating an extent of deviation between the abnormal data in the fourth period and the predicted abnormal data; and a detecting step that detects an insufficient time-series pattern from among time-series patterns indicating the normal state relating to the normal data, on the basis of the first deviation degree and the second deviation degree.

(Supplementary Note 4)

The computer program described in Supplementary Note 4 is a computer program that allows a computer to execute the learning method described in Supplementary Note 3.

(Supplementary Note 5)

The recording medium described in Supplementary Note 5 is a recording medium on which the computer program described in Supplementary Note 4 is recorded.

The present invention is not limited to the above-described examples and is allowed to be changed, if desired, without departing from the essence or spirit of the invention which can be read from the claims and the entire specification. A learning apparatus, a learning method, a computer program and a recording medium, which involve such changes, are also intended to be within the technical scope of the present invention.

This application is based upon and claims the benefit of priority from Japanese Patent Application No. 2019-051063, filed Mar. 19, 2019, the disclosure of which is incorporated herein in its entirety by reference.

### DESCRIPTION OF REFERENCE CODES

1 . . . learning apparatus, 111 . . . deviation degree calculation unit, 112 . . . insufficient data detection unit, 113 . . . user presentation unit

What is claimed is:

1. A learning apparatus that performs machine learning by using time-series numerical data as input data,
the learning apparatus comprising a controller,
the controller being programmed to:
generate a learning model for predicting and outputting time-series numerical data corresponding to inputted time-series numerical data, by performing the machine learning by using normal data that are time-series numerical data indicating a normal state as the input data;
compare predicted normal data in a second period corresponding to a first period, which are normal data predicted by the learning model by inputting, into the learning model, normal data in the first period out of the normal data, with normal data in the second period out of the normal data to obtain a first deviation degree indicating an extent of deviation between the normal data in the second period and the predicted normal data;
compare predicted abnormal data in a fourth period corresponding to a third period, which are abnormal data predicted by the learning model by inputting, into the learning model, abnormal data in the third period out of abnormal data that are time-series numerical data indicating an abnormal state, with abnormal data in the fourth period out of the abnormal data to obtain a second deviation degree indicating an extent of deviation between the abnormal data in the fourth period and the predicted abnormal data; and
detect an insufficient time-series pattern from among time-series patterns indicating the normal state relating to the normal data, on the basis of the first deviation degree and the second deviation degree.

2. The learning apparatus according to claim 1, wherein the controller is further programmed to present the detected insufficient time-series pattern.

3. A learning method in a learning apparatus that performs machine learning by using time-series numerical data as input data,
the learning method comprising:
generating a learning model for predicting and outputting time-series numerical data corresponding to inputted time-series numerical data, by performing the machine learning by using normal data that are time-series numerical data indicating a normal state as the input data;
comparing predicted normal data in a second period corresponding to a first period, which are normal data predicted by the learning model by inputting, into the learning model, normal data in the first period out of the normal data, with normal data in the second period out of the normal data to obtain a first deviation degree indicating an extent of deviation between the normal data in the second period and the predicted normal data;
comparing predicted abnormal data in a fourth period corresponding to a third period, which are abnormal data predicted by the learning model by inputting, into the learning model, abnormal data in the third period out of abnormal data that are time-series numerical data indicating an abnormal state, with abnormal data in the fourth period out of the abnormal data to obtain a second deviation degree indicating an extent of deviation between the abnormal data in the fourth period and the predicted abnormal data; and
detecting an insufficient time-series pattern from among time-series patterns indicating the normal state relating to the normal data, on the basis of the first deviation degree and the second deviation degree.

4. (canceled)

5. A non-transitory recording medium on which a computer program is recorded,
the computer program allowing a computer to execute a learning method,
the learning method being a learning method in a learning apparatus that performs machine learning by using time-series numerical data as input data,
the learning method comprising:
generating a learning model for predicting and outputting time-series numerical data corresponding to inputted time-series numerical data, by performing the machine learning by using normal data that are time-series numerical data indicating a normal state as the input data;
comparing predicted normal data in a second period corresponding to a first period, which are normal data predicted by the learning model by inputting, into the learning model, normal data in the first period out of the normal data, with normal data in the second period out of the normal data to obtain a first deviation degree indicating an extent of deviation between the normal data in the second period and the predicted normal data;
comparing predicted abnormal data in a fourth period corresponding to a third period, which are abnormal data predicted by the learning model by inputting, into the learning model, abnormal data in the third period out of abnormal data that are time-series numerical data indicating an abnormal state, with abnormal data in the fourth period out of the abnormal data to obtain a second deviation degree indicating an extent of deviation between the abnormal data in the fourth period and the predicted abnormal data; and
detecting an insufficient time-series pattern from among time-series patterns indicating the normal state relating to the normal data, on the basis of the first deviation degree and the second deviation degree.
